(19) United States
(12) Patent Application Publication
(10) Pub. No.: US 2015/0309521 A1
(43) Pub. Date: Oct. 29, 2015

(54) Cloud Based Power Management System

(71) Applicant: Yang Pan, Singapore (SG)

(72) Inventor: Yang Pan, Singapore (SG)

(21) Appl. No.: 14/264,056

(22) Filed: Apr. 29, 2014

(51) Int. Cl. G05F 1/66; H04L 29/08; G05B 15/02

(52) U.S. Cl. CPC G05F 1/66; G05B 15/02; H04L 67/10

(57) ABSTRACT

Cloud based power management system comprises a plurality of electrical appliances and a mobile communication device. Each of the electrical appliances is connected to a power manager connectable to the cloud. The power manager may limit the maximum power consumed by the appliance. The power manager may also eliminate phantom power consumed by the appliance. The power managers are controllable by the mobile communication device through the cloud.

### CROSS-REFERENCE TO RELATED APPLICATIONS

Not applicable

### BACKGROUND

1. Field of Invention

This invention relates to a power management system, specifically to a power management system including a means of remotely controlling of power consumptions of electrical appliances through a communication network.

2. Description of Prior Art

For various reasons, energy consumption is being increasingly scrutinized by residential and business consumers. Much effort has been made in recent years to provide electrical appliances of all types that consume reduced amount of electrical power. Such appliances have been well received in the market place and are highly desirable. While great strides have been made in providing energy efficient electrical appliances, more improvements are desired in particularly in areas of consuming of electrical power more efficiently including eliminating of phantom powers.

The so called phantom power or energy vampire is caused by standby power of electrical appliances such as, for example, televisions, digital video recorders, air conditioners, home audio systems and microwave ovens. The electrical appliances require the standby power to receive control signals from remote control devices to restart operations of the appliance from standby mode. Many billions of dollars have been wasted because of the phantom power that provides little or no desired functionalities of the electrical appliances. Many of such wastes are without a user's knowledge.

Therefore, it is desirable to increase the user's awareness of inefficient usage or wasting of powers. Today, most of users are equipped with mobile communication devices such as, for example, a smart phone and a tablet computer. It will be very helpful if such mobile devices can be used for the user to monitor power consumptions of various electrical appliances. It will be even more helpful if the mobile devices are used to control remotely power consumptions of the appliances.

### SUMMARY OF THE INVENTION

It is therefore an object of the present invention to providing a cloud based power management system by utilizing mobile communication devices.

It is another object of the present invention to providing a power manager for an electrical appliance that limits maximum allowed power consumption of the appliance.

It is yet another object of the present invention to providing a power manager for an electrical appliance that eliminates phantom power when the appliance is idle.

It is still another object of the present invention to providing a remote control means of limiting the maximum power or of eliminating the phantom power through the mobile communication device.

The power management system comprises a plurality of electrical appliances and a mobile communication device. Each of the electrical appliances further includes a power manager pertaining to limiting the maximum allowed power to the appliance or to eliminating the phantom power. The power managers are power management devices that are connected to the mobile communication device through a communication network. A user can control remotely operations of the power managers through the mobile communication device.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 shows, in a schematic diagram, an exemplary cloud based power management system, wherein power managers are connected to communication network through a network gateway;

FIG. 2 shows, in a schematic diagram, an exemplary cloud based power management system, wherein power managers are connected to communication network directly;

FIG. 3 shows, in a schematic diagram, an exemplary implementation of an AC power limiter;

FIG. 4 shows, in a schematic diagram, an exemplary implementation of a DC power limiter with AC power source;

FIG. 5 shows, in a schematic diagram, an exemplary implementation of a DC power limiter with DC power source;

FIG. 6 shows, in a flowchart, operations of the exemplary cloud based power management system;

FIG. 7 shows, in a flow chart, operations of the exemplary cloud based power management system including a surveillance system;

FIG. 8 shows, in a table form, user interface of the mobile communication device for managing power consumptions of the electrical appliances.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

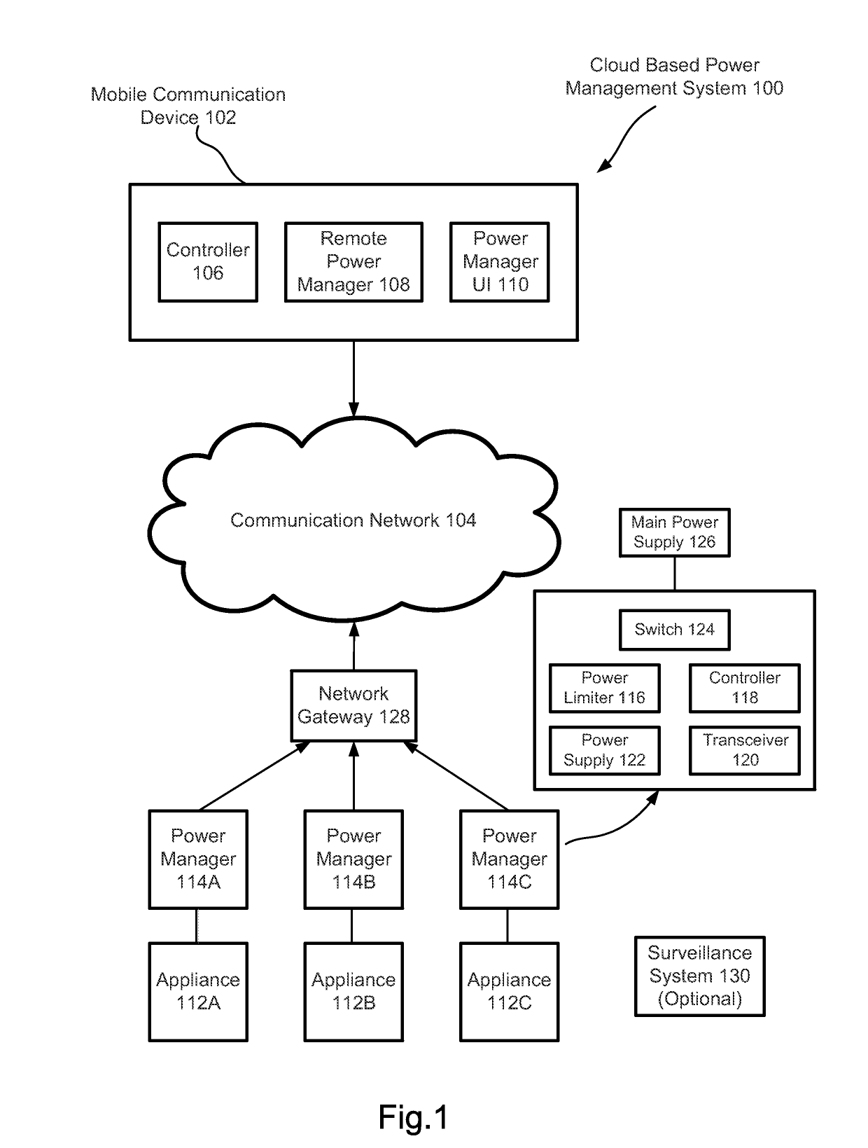

FIG. 1 is a schematic diagram of an exemplary power management system. Cloud based power management system 100 includes a mobile communication device 102. Mobile device 102 includes but is not limited to a mobile phone, a tablet computer, a laptop computer, a wearable electronic device such as, for example, an electronic watch and an electronic glass. Mobile device 102 is connected to a communication network 104. In one implementation, communication network 104 is the Internet. In another implementation, communication network 104 is a short range ad hoc communication network including but is not limited to a Bluetooth type of network, a ZigBee type of network and a WiFi type of network. Mobile device 102 further includes a controller or processor 106, a remote power manager 108 and a power management user interface (UI) 110.

Remote power manager 108 manages remotely power consumptions of a plurality of electrical appliances through the communication network 104. Appliance 112A-C is illustrated in FIG. 1 in an exemplary manner only. More or less appliances may be included and be controlled. The appliances may be located in a confined area such as in a home or in an office. The appliances may also be located in more than one confined area. Each of the appliances is connected to a power manager (illustrated as 114A-C in FIG. 1). The power manager further includes a power limiter 116, a controller 118, a transceiver 120 and a power supply 122. The power manager is connected to a main power supply 126 through a switch 124. The power limiter 116 is a programmable device controlled by controller 118. Power limiter 116 limits the maximum allowed power to be supplied to the appliance from the main power supply 126. The maximum power can be set up by controller 118. Mobile device 102 sends an instruction through the communication network 104. The instruction is received by the transceiver 120 and is subsequently received by the controller 118. A user can change the maximum allowed power through the mobile device 104 at any time.

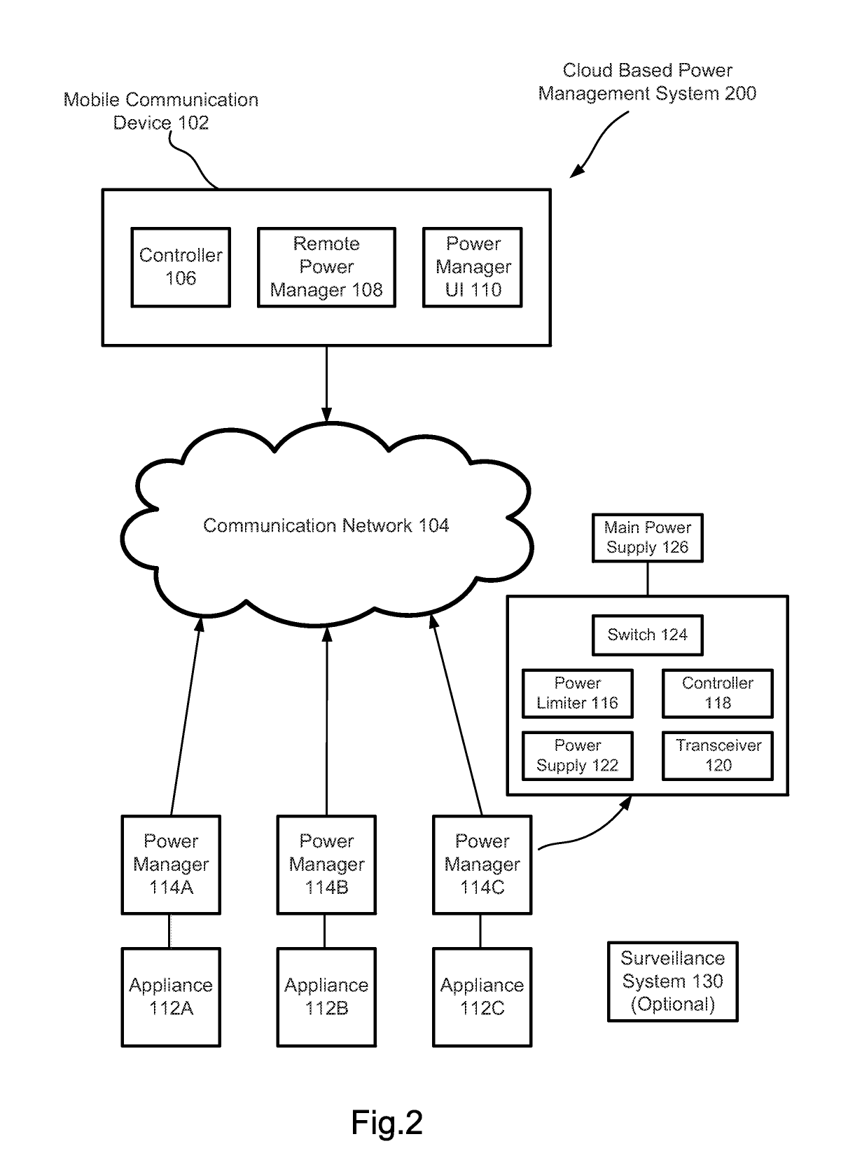

In one implementation, the power managers are connected to network 104 through a network gateway 128 as shown in FIG. 1. In another implementation, the power managers are connected to the network 104 directly as shown in FIG. 2.

The main power supply 126 is an AC power supply in one implementation. The AC power supply is connected to a power grid. The main power supply 126 is a DC power supply in another implementation. The DC power may be converted from an AC power supply through an AC/DC converter.

The power supply 122 for the power manager is a replaceable battery in one implementation. The power supply 122 is a rechargeable battery in another implementation. The power supply 122 may also include other power storage means including but is not limited to a capacitor.

In one implementation, the power manager includes the power limiter 116 and does not include the switch 124. In another implementation, the power manager includes the switch 124 and does not include power limiter 116. In yet another implementation, the power manager includes both the power limiter 116 and the switch 124.

The switch 124 switches off the appliance from the main power supply 126 completely without phantom power when a control signal from the controller 118 is received. In one implementation, switch 124 is a relay. The control signal may be a result from a user's sending an instruction from the mobile device 102 to the power manager.

Power management system 100 (FIG. 1) or power management system 200 (FIG. 2) may also include a surveillance system 130 pertaining to monitoring status of occupancy of the confined area (i.e. a home or an office). Surveillance system 130 sends the status to the mobile device 102 through the communication network 104. Surveillance system 130 may include one or more digital cameras in one implementation. Surveillance system 130 may include a system that determines mobile communication devices in the confined area and derives amounts and identities of persons in the area.

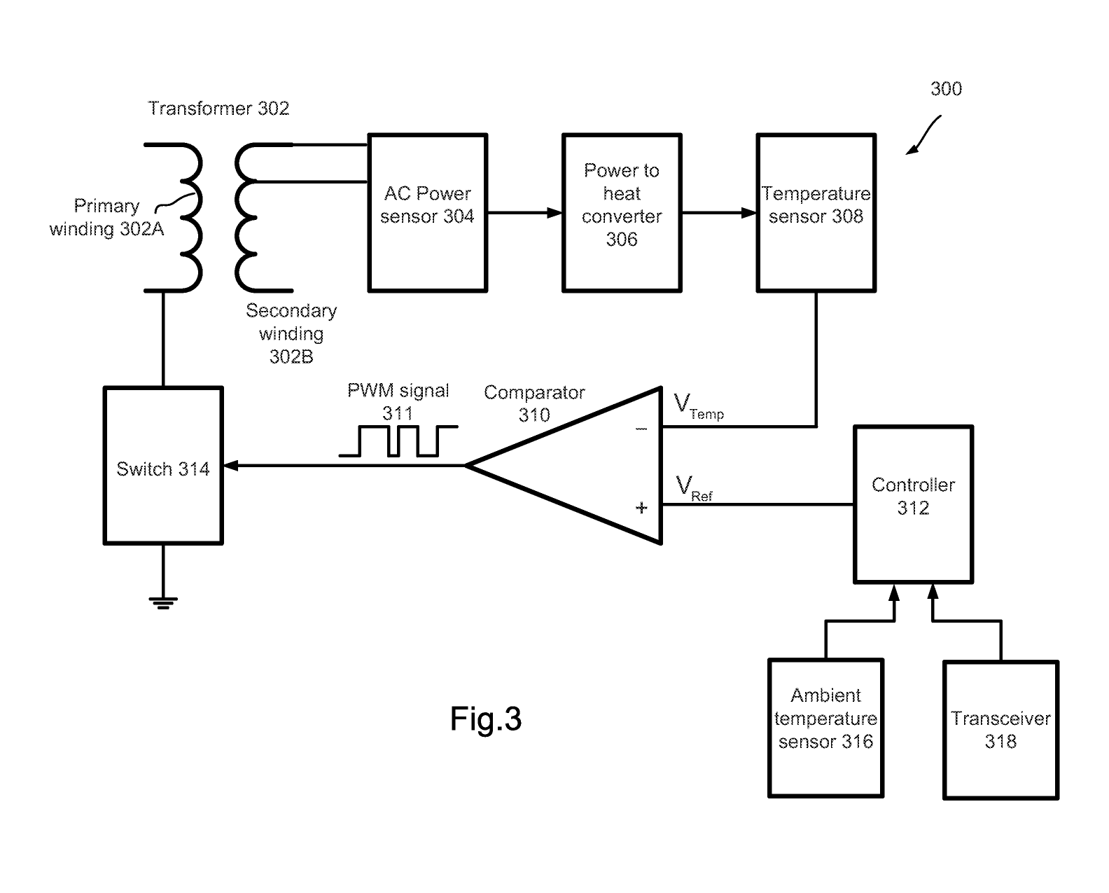

FIG. 3 is an exemplary power limiter implemented in AC power domain based upon an integrated circuit for measurements of thermal signals comprising a thermal feedback loop.

Such an implementation is known from an article by Pan (the present inventor) and Huij sing in Electronic Letters 24 (1988), 542-543. This circuit is theoretically appropriate for measuring physical quantities such as speed of flow, pressure, IR-radiation, or effective value of electrical voltage or current (RMS), the influence of the quantity grated integrated circuit (chip) to its environment being determined in these cases. In these measurements, a signal conversion takes place twice: from physical (speed of flow, pressure, IR-radiation or RMS value) to the thermal domain, and from the thermal to the electrical domain.

This known semiconductor circuit theoretically consists of a heating element, integrated in the circuit, and a temperature sensor. The power dissipated in the heating element is measured with the help of an integrated amplifier unit, an amplifier with a positive feedback loop being used, because of which the temperature oscillates around a constant value with small amplitude. In the known circuit the temperature will oscillate in a natural way because of the existence of a finite transfer time of the heating element and the temperature sensor with a high amplifier-factor.

FIG. 3 shows a novel implementation of the thermal feedback principle as mentioned above to AC power limiter 300. AC power limiter 300 comprises a transformer 302 including primary winding 302A and secondary winding 302B. Transformer 302 converts AC power with high amplitude in primary winding 302A to AC power with low amplitude in secondary winding 302B while maintaining the power almost constant. AC Power sensor 304 coupled to secondary winding 302B receives a portion of AC power proportionally. Power sensor 304 may further comprise a current sensor and/or a voltage sensor. The received AC power is further coupled to power heat converter 306 that may include a heating element. The heating element may be a heating resistor in an exemplary case. The heating element may also be an active component. Power to heat converter 306 (heating element) may be a part of an integrated circuit or a chip. According to a different implementation, a rectifier (not shown in FIG. 3) may be used to convert the AC power into DC power before it is used to heat the heating element.

Temperature sensor 308 in the same integrated circuit is used to measure the temperature of the integrated circuit (chip). According to one implementation of the present invention the heating element and temperature sensor may be placed in a microstructure such as a membrane or a cantilever beam, manufactured by a micromachining technology.

Output of temperature sensor 308 is coupled to one input of comparator 310. Reference generated by controller 312 is coupled to another input of comparator 310. Output of comparator 310, which is a Pulse-Width Modulation (PWM) signal, is coupled to switch 314 that is connected to primary winding 302A of transformer 302 to form a positive feedback loop. Switch 314 may be implemented in various forms as known in the art. Switch 314 may be a power Metal Oxide Semiconductor Field Effect Transistor (MOSFET) according to an implementation. Switch 314 may be a bipolar transistor according to another implementation. Switch 314 may even be a Light Emitting Diode (LED) and a photo detector. The output of comparator 310 may be used to drive the LED to emit light that will be detected by the photo detector. As soon as the measured temperature by temperature sensor 308 exceeds a predetermined value, set by the reference, the output of the comparator switches off switch 314. As a result, power sensor 304 receives no power from secondary winding 302B and the output of temperature sensor 308 starts to drop. As soon as the output is below the reference, the output of comparator 310 switches on switch 314 and therefore primary winding 302A. The temperature of the chip or the microstructure will oscillate around a small value. The output power of secondary winding 302B will remain as a constant in a sine wave form modulated by the PWM signals. The output power of transformer 302 is limited by the duty cycle of the PWM signal. The output power may be delivered to the electrical appliance.

The maximum output power of transformer 302 is determined by the reference that sets a level of temperature that the chip or the microstructure will oscillate around. To sustain a higher temperature, the power sensor will need to draw more power from the secondary winding 302B. The reference is determined by controller 312 that receives the instructions from transceiver 318 that is connected to mobile device 102 through communication network 104. In an unlimited power operation mode, controller may 312 my set the reference to a sufficiently high level to maintain switch 314 in an “on” state.

The present power limiter can be used to eliminate the phantom power when an electrical appliance connected to the main power supply is idle. Transceiver 318 receives an instruction from the mobile device 102 to eliminate the phantom power. Controller 312 sets the reference to a sufficiently low level to maintain switch 314 in an “off” state. No power will be delivered from transformer 302 to the electrical appliance.

It should be noted that the temperature level of the microstructure or the chip also depends on ambient temperature. At a lower ambient temperature, it requires more power to heat the heating element to maintain the temperature to oscillate around the predetermined level. At a higher ambient temperature, less power is required. In one aspect of the present invention, an ambient temperature sensor 316 is used to measure the ambient temperature. The measurement results are sent to controller 312. Controller 312 determines the reference based upon not only the instructions from the mobile communication device 102 but also the ambient temperature measured by temperature sensor 316. Temperature sensor 316 may be a sensor independent of the integrated circuit or the chip. Temperature sensor 316 may also be a part of the integrated circuit or the chip that will require an appropriate thermal isolation between temperature sensor 306 and temperature sensor 316. Such thermal isolation techniques are known in the art.

There may be different implementations of integration level of system 300. At a minimum level, 306 and 308 are integrated in a single chip or in a single microstructure. At a higher level, 310 may also be integrated (e.g. 306, 308 and 310 in a single chip). At even higher levels, 312 and 314 may also be integrated (e.g. 306, 308, 310, 312 and 314 in a single chip). At still higher level, 316 and 318 may also be integrated (e.g. 306, 308, 310, 312, 314, 316 and 318 in a single chip). All such variations shall fall within scope of inventive concepts of the present invention.

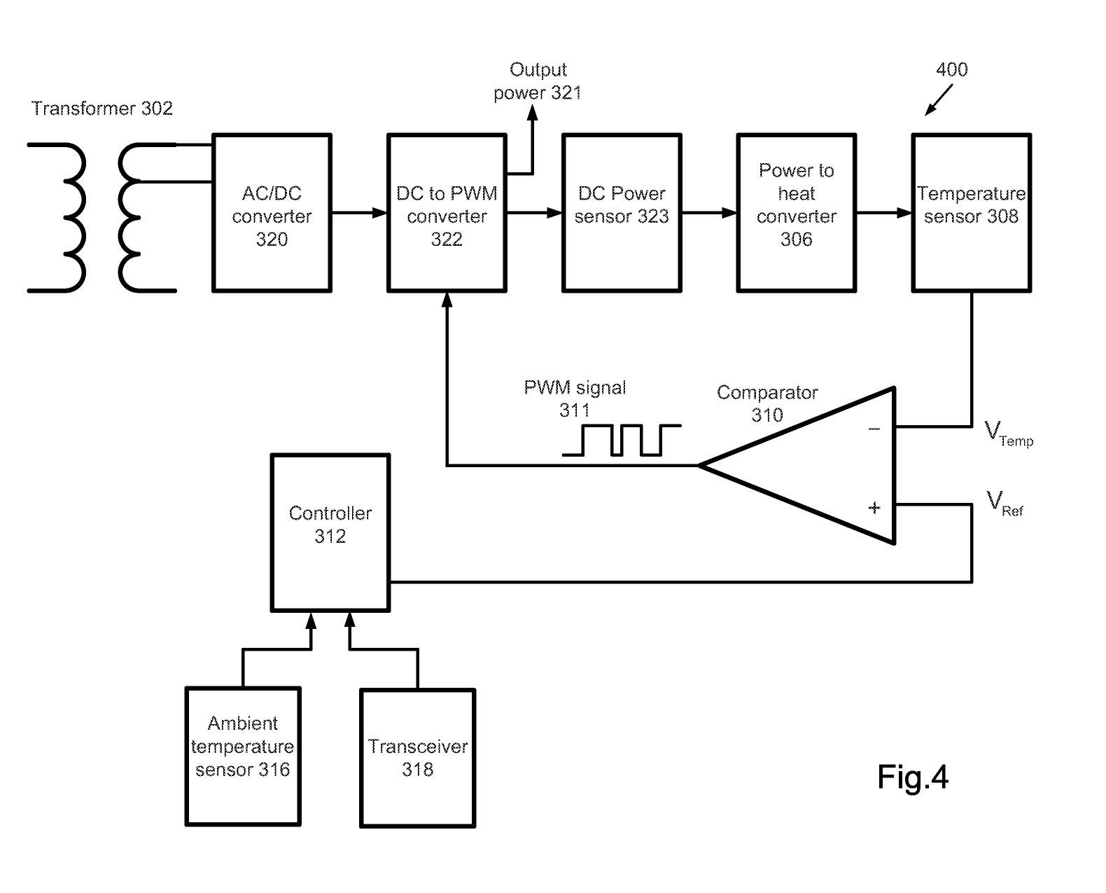

FIG. 4 shows an exemplary power limiter implemented in DC power domain with AC power source. System 400 comprises AC/DC converter 320 that converts output power of transformer 302 from AC form into DC form. Block 322 modulates the DC power by PWM signal 311. DC power sensor 323 is coupled to Block 322 to draw a portion of DC power proportionally. Block 322 delivers output power 321 in PWM form. The DC power received by DC power sensor 323 is coupled to power to heat converter (heating element) 306. Temperature sensor 308 measures temperature of the microstructure (chip) that includes the heating element. Comparator 310 takes one input from the output of temperature sensor 308 and takes another input from a reference generated from controller 312. Output of comparator 310 in PWM form (311) is coupled to block 322 to modulate the DC power. The temperature of the chip will oscillate around a small value set by the reference. Block 322 converts output of AC/DC converter 320 into DC power in PWM form. The output power of block 322 is therefore determined by duty cycle of the PWM signal while the amplitude is kept constant. The output power of block 322 may be further processed into DC and/or AC powers before it is delivered to appliances.

Similar to FIG. 3, controller 312 is coupled to ambient temperature sensor 316 and transceiver 318. Functionalities of 316 and 318 are similar to ones that have been described previously in the AC power limiter session.

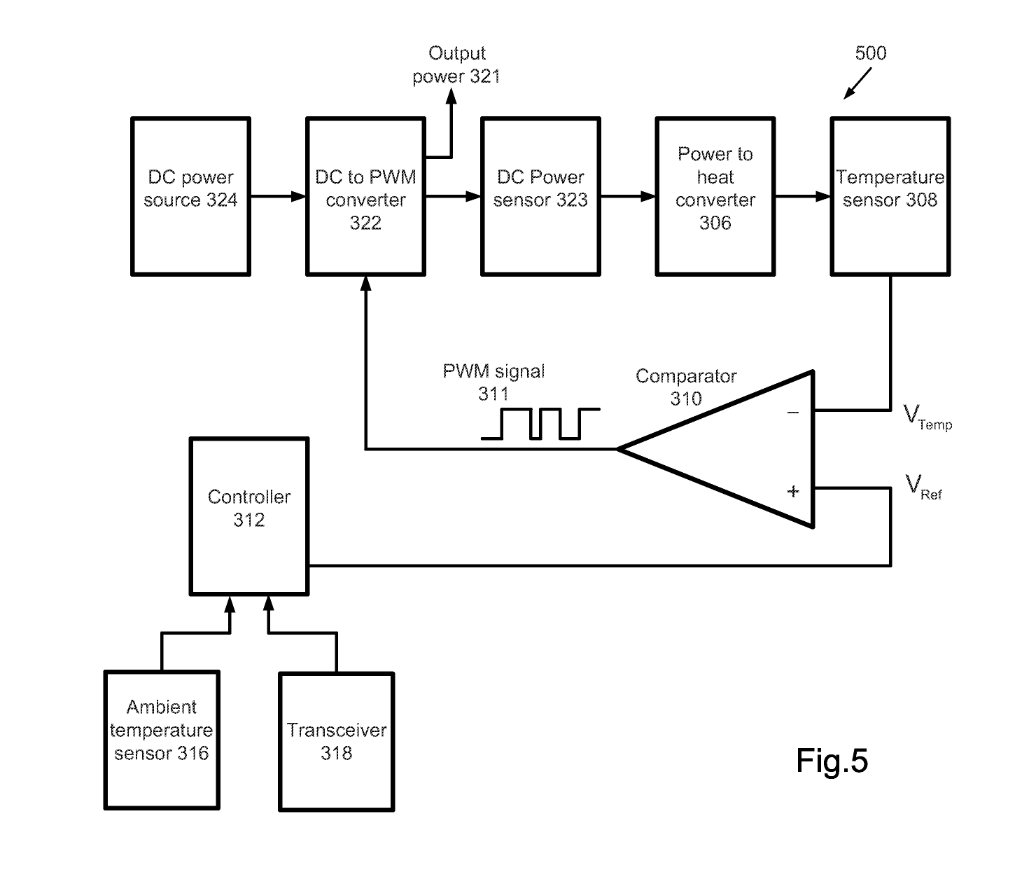

FIG. 5 shows an exemplary power limiter implemented in DC power domain with DC power source 324. Power limiter 500 is the same as power limiter 400 except that transformer 302 and AC/DC converter 320 are replaced by the DC power source 324.

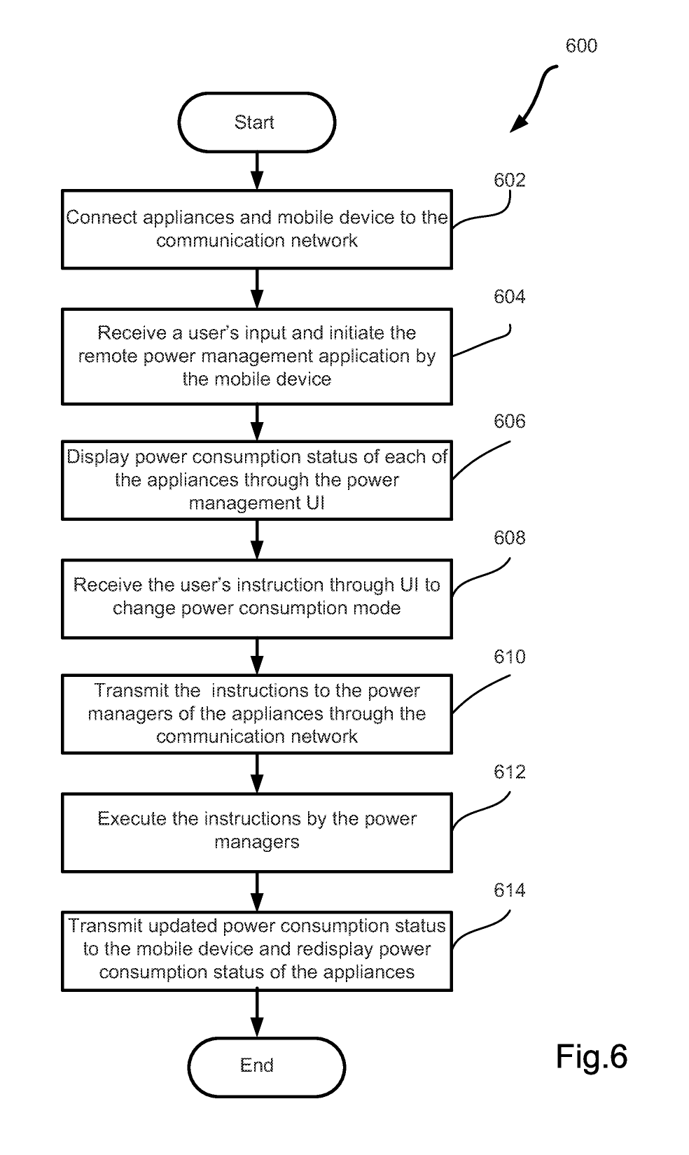

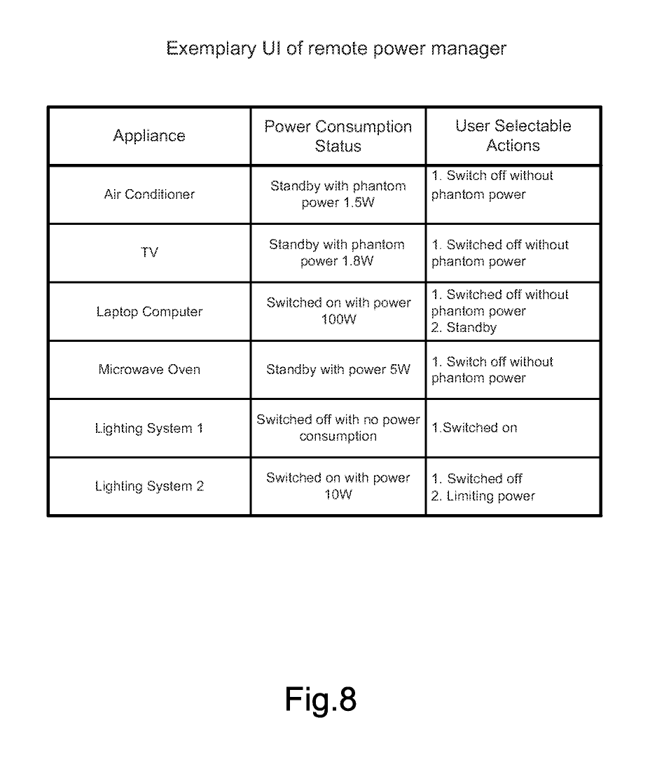

FIG. 6 shows, in a flowchart, operations of the exemplary power management system 100. Process 600 starts with step 602 that the electrical appliances and the mobile devices 102 are connected to communication network 104. In one implementation, the communication network 104 is the Internet. In another implementation, the communication network 104 is a short range ad hoc communication network. In step 604, a user's action or input is received by the mobile device 102 and the remote power management application in the mobile device 102 is initiated. In one implementation for the mobile device 102 with a touch sensitive display the user may initiate the App by touching an associated icon. In response to the user's action, a UI is displayed in step 606. An exemplary UI is illustrated in FIG. 8. The electrical appliances include apparatus such as, for example, an air conditioner, a TV, a laptop computer, a microwave oven, a number of lighting systems. Present power consumption status for each of the appliances is displayed. User selectable actions are also listed including switching off completely an appliance, putting an appliance into standby, limiting the maximum allowed power of an appliance.

In step 608, the user's selections to change the power consumption mode for the appliance are received by the mobile device 102 through the UI. The user's instructions are transmitted to the power managers connected to the appliances in step 610 through the communication network 104. Controllers 118 receive the instruction and executed the instruction accordingly in step 612. Updated power consumption status can then be transmitted to the mobile device 102 in step 614.

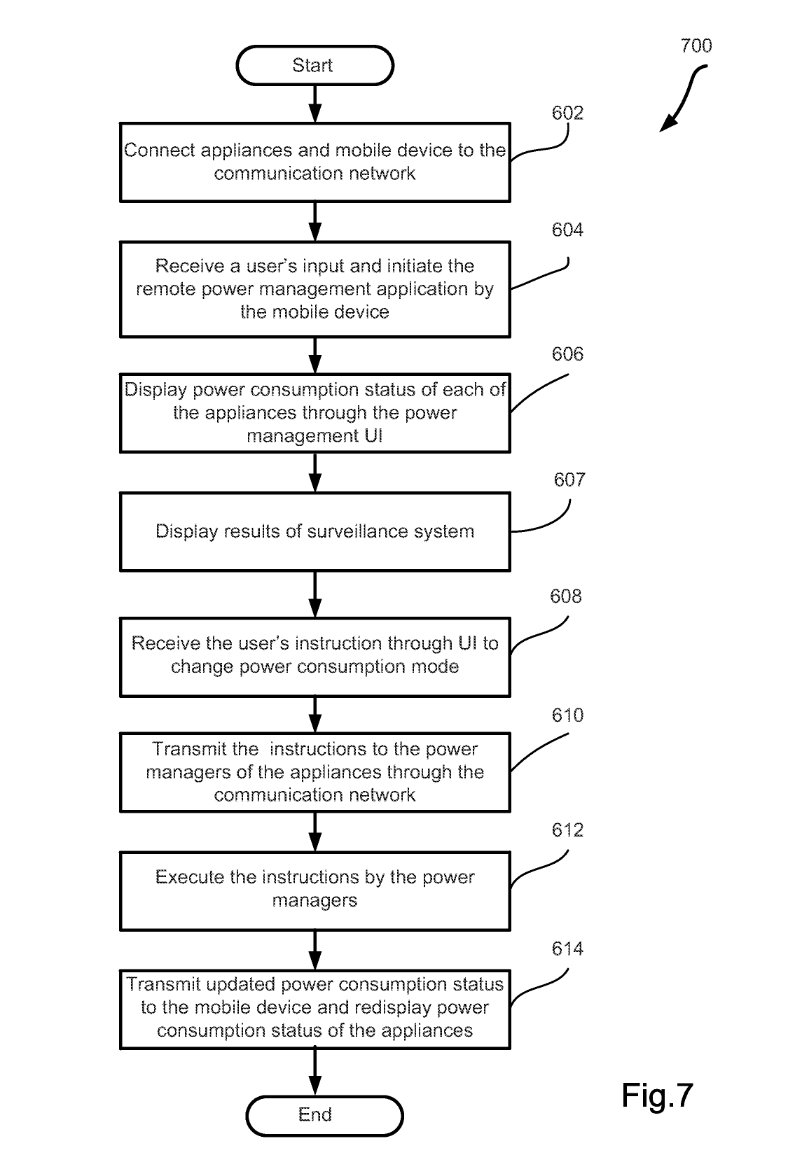

FIG. 7 shows, in a flow chart, operations of the exemplary power management system 100 including a surveillance system. Process 700 is similar to process 600 except for an added step 607. In step 607 occupancy status determined by the surveillance system of a confined area such as a home or an office is displayed on the mobile device 102. The user determines his or her actions to change power consumption modes of the appliances based at least partly on the displayed surveillance results. For example, the user may take different actions to manage the power consumption when there is a person or there is no person at home.

1. A power management system comprising:
(a) a plurality of electrical appliances, each of the appliances is connected to a power manager, said power manager further including a communication unit and a programmable power limiter connecting between a power supply and the appliance;
(b) a mobile communication device pertaining to controlling remotely the power managers; and
(c) a communication network pertaining to connecting said mobile communication device and said power managers.

2. The system as recited in claim 1, wherein said power manager further comprising a controller pertaining to setting up and changing the maximum power consumption of the appliance, wherein said controller receives an instruction from said mobile communication device through said communication network.

3. The system as recited in claim 1, wherein said power manager further comprising a controller pertaining to eliminating phantom power when said appliance is idle, wherein said controller receives an instruction from said mobile communication device through said communication network.

4. The system as recited in claim 3, wherein said power manager further comprising a switch pertaining to switching off the appliance from the power supply completely.

5. The system as recited in claim 1, wherein said communication network is the Internet.

6. The system as recited in claim 1, wherein said communication network is a short rang ad hoc communication network.

7. The system as recited in claim 6, wherein said short range ad hoc communication network further comprising a Bluetooth type of communication network.

8. The system as recited in claim 6, wherein said short range ad hoc communication network further comprising a ZigBee type of communication network.

9. The system as recited in claim 6, wherein said short range ad hoc communication network further comprising a WiFi type of communication network.

10. The system as recited in claim 1, wherein said mobile communication device further comprising a user interface for managing power consumptions of the appliances, wherein said user interface displays on a display screen of said mobile communication device a plurality of user selectable items including changing the maximum allowed power consumption of selected appliances and eliminating phantom power of idled appliances.

11. The system as recited in claim 1, wherein said plurality of electrical appliances are located in a confined area, wherein said confined area further comprising a surveillance system pertaining to determining status of occupancy by one or more persons, wherein said mobile communication device receives the status from said surveillance system and sends an instruction to said power managers.

12. The system as recited in claim 1, wherein said power limiter is based upon a thermal feedback loop comprising a heating element, a temperature sensor, a comparator and a reference signal, wherein said reference signal is changeable by said mobile communication device through said communication network.

13. The system as recited in claim 1, wherein said power limiter is an AC power limiter.

14. The system as recited in claim 1, wherein said power limiter is a DC power limiter.

15. The system as recited in claim 14, wherein said DC power limiter is connected to a DC/AC converter.

16. The system as recited in claim 1, wherein said mobile communication device further comprising a mobile phone.

17. The system as recited in claim 1, wherein said mobile communication device further comprising a tablet computer.

18. The system as recited in claim 1, wherein said mobile communication device further comprising a wearable electronic device.

19. A power management system comprising:
(a) a plurality of electrical appliances, each of the appliances is connected to a power manager, said power manager further including a communication unit, a controller and a switch pertaining to switching off the appliance from a power supply completely to eliminate phantom power when a control signal from the controller is received;
(b) a mobile communication device pertaining to sending an instruction to said controller to trigger said controller to send said control signal; and
(c) a communication network pertaining to connecting said mobile communication device and said power managers.

20. A power management system comprising:
(a) a plurality of electronic appliances located in a confined area, each of the appliances is connected to a power manager, said power manager further including a communication unit and a programmable power limiter connecting between a power supply and the appliance;
(b) a mobile communication device pertaining to controlling remotely power managers;
(c) a communication network pertaining to connecting said mobile communication device and said power management devices; and
(d) a surveillance system installed in the confined area pertaining to determining a status of occupancy of said confined area by one or more persons, wherein said mobile communication device receives the status from said surveillance system and send an instruction to the power manager.
